(19) United States
(12) Patent Application Publication
(10) Pub. No.: US 2021/0408620 A1
(43) Pub. Date: Dec. 30, 2021

(54) HEAT DISSIPATING STRUCTURE

(71) Applicant: TVS MOTOR COMPANY LIMITED, Chennai (IN)

(72) Inventors: Sivanesaselvam Thangarajan, Chennai (IN); Senthilnathan Subbiah, Chennai (IN); Samraj Jabez Dhinagar, Chennai (IN)

(73) Assignee: TVS MOTOR COMPANY LIMITED, Chennai (IN)

(21) Appl. No.: 17/292,267

(22) PCT Filed: Nov. 7, 2019
(86) PCT No.: PCT/IN2019/050823

§ 371 Date: May 7, 2021

(30) Foreign Application Priority Data
Nov. 8, 2018 (IN) 201841042116

(51) Int. Cl. H01M 10/6551; H01M 10/613; H01M 10/625; H01M 10/6562; H01M 10/42; H01M 50/209

(52) U.S. Cl. CPC H01M 10/6551; H01M 10/613; H01M 10/625; H01M 2010/4271; H01M 10/425; H01M 50/209; H01M 2220/20; H01M 10/6562

(57) ABSTRACT

An energy storage pack includes at least one energy storage device, a battery management system (BMS) electrically coupled to at least one side of the at least one energy storage device and at least one heat dissipating structure slidably positioned to the at least one side of the at least one energy storage device and in alignment thereof. The at least one heat dissipating structure includes at least one airflow guiding portion and at least one securing portion integrally formed with the at least one airflow guiding portion and extending laterally outward from at least a portion thereof.

### TECHNICAL FIELD

The present invention relates to at least one heat dissipating structure. More particularly, the present invention relates to said at least one heat dissipating structure for a battery management system (BMS) for at least one energy storage device of an energy storage pack.

### BACKGROUND

In recent years, rechargeable energy storage devices have been widely used as an energy source for a number of electronic and electrical units, hybrid and electric vehicles. Commonly used rechargeable energy storage devices include, for example, nickel cadmium batteries, nickel hydrogen batteries, nickel zinc batteries, and lithium rechargeable batteries. Lithium rechargeable energy storage devices are widely used in electric and hybrid vehicles because they are rechargeable, they can be made in a compact size with large capacity, they have a high operation voltage, and they have a high energy density per unit weight.

An existing energy storage pack comprises at least one energy storage device. Typically, said at least one energy storage device includes at least one holder structure configured to hold one or more energy storage cells therein. The one or more energy storage cells are disposed in at least one configuration. A battery management system (BMS) configured for efficiently managing the charge and discharge of said at least one energy storage device, such as by measuring the voltages and/or current of said one or more energy storage cells is electrically connected to at least one side of said at least one energy storage device. Generally, at least one interconnecting structure is adapted for electrically interconnecting said one or more energy storage cells with the battery management system (BMS). An output voltage and an output current generated by said at least one energy storage device is transmitted to one or more electronic and electrical components configured to be powered by said energy storage pack after being monitored and regulated by said battery management system (BMS).

In a known energy storage pack, the battery management system (BMS) adapted to monitor said voltage generated by said one or more energy storage cells comprises of at least one printed circuit board (PCB) including one or more integrated circuits such as field effect transistors, known as MOSFETs, to control the flow of current from said at least one energy storage device to the one or more electronic and electrical components configured to be powered thereby. During discharging and charging process of said one or more energy storage cells of said at least one energy storage device, said one or more integrated circuits of said battery management system (BMS) generates a large amount of heat which is likely to melt solder connections of said one or more integrated circuits on said at least one printed board (PCB), thereby damaging said battery management system (BMS) and hence degrading performance of said at least one energy storage device and furthermore results in high cost and frequent replacement for said battery management system (BMS) of said at least one energy storage pack.

### BRIEF DESCRIPTION OF THE DRAWINGS

The detailed description is described with reference to the accompanying figures. The same numbers are used throughout the drawings to reference like features and components.

FIG. 1 is a perspective view of an energy storage pack including at least one energy storage device, as per one embodiment of the present invention.

FIG. 2 is an exploded view of the energy storage pack of FIG. 1, as per one embodiment of the present invention.

FIG. 3 is an exploded view of the energy storage pack including at least one heat dissipating structure, as per one embodiment of the present invention.

FIG. 4 is a perspective view of an outer casing of the energy storage pack of FIG. 1, as per one embodiment of the present invention.

FIG. 5 is an enlarged exploded view of at least a portion of the energy storage pack of FIG. 1 illustrating said at least one heat dissipating structure, as per one embodiment of the present invention.

FIG. 6 is perspective view of said at least one heat dissipating structure of said energy storage pack, as per one embodiment of the present invention.

FIG. 7a is a front view of said at least one heat dissipating structure of FIG. 6, as per one embodiment of the present invention.

FIG. 7b is a side view of said at least one heat dissipating structure of FIG. 6, as per one embodiment of the present invention.

FIG. 8 is a cross-sectional view of the energy storage pack taken along line LL′ in FIG. 1 along a transverse direction thereof, as per one embodiment of the present invention.

### DETAILED DESCRIPTION

Typically, a rechargeable energy storage pack comprises of a plurality of energy storage cells in one or more configurations of series and parallel arrays and being disposed in at least one holder structure of at least one energy storage device. The rechargeable energy storage pack is protected from over-charging and over-discharging and charging is controlled by a battery management system (BMS). The battery management system (BMS) is configured for managing the state-of-charge (SOC) of said at least one energy storage device of the energy storage pack.

Conventionally, the battery management system (BMS) is equipped with said at least one energy storage device of the energy storage pack for monitoring one or more energy storage cells during charging and discharging process. The battery management system (BMS) includes at least one printed circuit board (PCB) including one or more integrated circuits being integrally built therein through one or more soldering networks. However, during charging and discharging process of the one or more energy storage cells of said at least one energy storage device, the one or more integrated circuits of said battery management system (BMS) adapted for monitoring and regulating the output voltage and the output current of the one or more energy storage cells generates a large amount of heat which results in a significant temperature rise in at least a portion of said battery management system (BMS) which then can damage said at least one printed circuit board (PCB) of the battery management system (BMS) when such heat cannot dissipates to the outside in time.

Generally, a metal plate structure in the form of a heat dissipating structure is attached to the battery management system (BMS) through one or more fasteners. The conventional heat dissipating structure includes a plurality of fins integrally formed to at least a portion therewith and adapted to dissipate at least a portion of the heat generated by the one or more integrated circuits of the battery management system (BMS). However, since said one or more energy storage cells are disposed in a closed configuration of series or parallel arrays in said at least one energy storage device of the energy storage pack and said at least one heat dissipating structure is detachably attached to said at least a portion of the battery management system (BMS), hence the dissipation of heat generated by said one or more integrated circuits can take place only through said plurality of the fins of said heat dissipating structure, i.e. only at least a portion of the total heat generated can dissipate through said plularity of fins provided in the heat dissipating structure whereas at least some portion of the heat still remains over at least a portion of said battery management system (BMS) which can damage at least one circuitry of said battery management system (BMS). Thus, the existing design of said heat dissipating structure is ineffective in providing adequate cooling mechanism for said battery management system (BMS).

With the above objectives in view and to overcome all of the above problems, the present invention provides an improved design for said at least one heat dissipating structure for the battery management system (BMS) equipped with said at least one energy storage device in said energy storage pack. More particularly, the object of the present invention is to provide said improved design for said at least one heat dissipating structure for said at least one energy storage device which establishes an improved heat dissipation characteristics for said battery management system (BMS) during charging and discharging of said one or more energy storage cells of said at least one energy storage device and hence provides an improved cooling mechanism for said battery management system (BMS), thereby facilitating an improved performance of said at least one energy storage device and in addition provides extended useful life for said one or more energy storage cells. Furthermore, the improved said at least one heat dissipating structure facilitates an enhanced cooling mechanism for said battery management system (BMS) and hence prevents damage to said at least one printed circuit board (PCB) of said battery management system (BMS) due to the heat generated by said one or more integrated circuits. Further, as per one embodiment of the present invention, said improved design for said at least one heat dissipating structure comprises an improved heat-dissipation capability which facilitates an enhanced cooling mechanism for said battery management system (BMS) and in addition provides uniformity of temperature of said energy storage pack.

According to one embodiment, the energy storage pack comprises at least one energy storage device, the battery management system (BMS) electrically coupled to at least one side of said at least one energy storage device and said at least one heat dissipating structure slidably positioned to said at least one side of said at least one energy storage device and in alignment thereof. In one embodiment, said at least one heat dissipating structure includes at least one airflow guiding portion and at least one securing portion integrally formed with said at least one airflow guiding portion and extending laterally outward from at least a portion thereof. As per one embodiment of the present invention, said at least one airflow guiding portion includes a back wall having a flat surface and a plurality of fins projecting from an opposing side of said flat surface of said back wall. Particularly, said plularity of fins are provided to at least a portion of said at least one airflow guiding member to increase the surface area of said at least one heat dissipating structure with surrounding air being guided to said at least a portion of the battery management system (BMS) to effect at least some amount of heat dissipation from the battery management system (BMS) through said at least one heat dissipating structure and then to the outside.

In one embodiment, said at least one airflow guiding portion is positionable in parallel with said at least one side of said at least one energy storage device. Further, said at least one securing portion includes an extending member extending laterally from at least a portion of said back wall of said at least one airflow guiding portion and a securing member integrally formed with said extending member. As per one embodiment of the present invention, said extending member extends in a common plane with said flat surface of said back wall at a predetermined angle to a plane of said securing member of said at least one securing portion. Particularly, said extending member is oriented at said predetermined angle in the range of 85° to 95° with said securing member of said at least one securing portion. Furthermore, as per one embodiment of the present invention, said at least one heat dissipating structure is adapted to direct dissipation of said at least some amount of heat generated by at least one circuitry of said battery management system (BMS) through said back wall and said extending member along said common plane in a first predetermined direction and through said at least one securing member along said plane in a second predetermined direction. As per one embodiment, the securing member is thermally coupled with an outer casing of said at least one energy storage device. The securing member is configured to guide dissipation of said at least some amount of heat in a third predetermined direction through said outer casing to the outside.

Further, as per one embodiment, said at least one airflow guiding portion of said at least one heat dissipating structure includes one or more fastener receiving portions configured to receive one or more fasteners for detachably attaching said at least one heat dissipating structure to said battery management system (BMS) in said at least one side of said at least one energy storage device. Referring to one embodiment, the battery management system (BMS) extends substantially along a length of said at least one energy storage device. In one embodiment, the outer casing of said energy storage pack is configured to accommodate said at least one energy storage device therein. The outer casing comprises one or more groove structures being integrally formed along a transverse direction with at least a portion of an inner surface thereof. In one embodiment, said at least one energy storage device when accommodated in said outer casing forms at least a gap portion therebetween. As per one embodiment of the present invention, said at least one securing portion is configured for slidably securing said at least one heat dissipating structure to said at least one side of said at least one energy storage device through said at least a gap portion along at least a portion of said one or more groove structures.

In one embodiment of the present invention, the improved design for said at least one heat dissipation portion includes said at least one airflow guiding portion and said at least one securing portion extending laterally from at least a portion of the airflow guiding portion such that the heat generated by said one or more integrated circuits in said at least one printed circuit board (PCB) is dissipated along one or more predetermined directions including the first predetermined direction, the second predetermined direction and the third predetermined direction through said at least one heat dissipating structure to the outside. Particularly, as per one embodiment of the present invention, said at least one heat dissipating structure is made up of a thermally conductive material including aluminium, copper, etc. due to the ability of metals like copper and aluminium to readily absorb heat and transfer it about its entire structure. The improved design of said at least one heat dissipating structure including said at least one airflow guiding portion and said at least one securing portion extending outwardly from said at least one airflow guiding portion are in contact with said at least a portion of the thermally conductive outer casing of the energy storage pack which facilitates an improved heat dissipation from said battery management system (BMS) to outside due to the conduction of the heat from said a least a portion of the battery management system (BMS) through said at least one heat dissipating structure to the outer casing and hence to the outside of the energy storage pack. Thus, in order to improve the heat dissipation from the battery management system (BMS), the one embodiment of the present invention provides an improved said at least one heat dissipating structure which includes an extending structure in the form of said at least one securing portion extending outwardly from said at least one airflow guiding portion. In one embodiment, said securing member of said at least one securing portion establishes a contact with said outer casing through the conduction heat transfer which then dissipates the heat to outside. Furthermore, in one embodiment of the present invention, said at least a portion of the heat generated by said battery management system (BMS) during charging and discharging process of said at least one energy storage device is dissipated through said plularity of fins formed in the opposite side of said backwall of said at least one airflow guiding structure till a predetermined saturation level and said at least some amount of the heat generated by the battery management system (BMS) is dissipated through said back wall, the extending member and said securing member of said at least one heat dissipating structure to the outer casing through conduction heat transfer and then to the outside of said energy storage pack.

The object of the present invention is to provide an improved design for said at least one heat dissipating structure for said battery management system (BMS) for said at least one energy storage device which can facilitate an enhanced cooling mechanism for the battery management system (BMS) by efficiently dissipating the heat generated by said one or more integrated circuits being integrally built in said printed circuit board (PCB) of said battery management system (BMS).

Another object of the present invention is to provide an improved design for said at least one heat dissipating structure for said battery management system (BMS) that can effectively maximize the dissipation of the heat generated by said battery management system (BMS) through the conduction heat transfer mechanism between said battery management system (BMS) and said outer casing of said at least one energy storage device and said at least one heat dissipating device to outside such that the heat from said at least one heat dissipating structure gets spread to said outer casing and hence to the outside. Thus, with said improved design, the heat dissipating capability of said at least one heat dissipating structure is enormously improved.

Still another object of the present invention is to provide an improved design for said at least one heat dissipating structure formed of a thermally conductive material including aluminium, copper, etc. Thus, in one embodiment, the improved said at least one heat dissipating structure being thermally connected to said outer casing being made up of aluminium material can dissipate the heat from said battery management system (BMS) through said at least one heat dissipating structure to the outside.

Further, as per one embodiment, the present invention provides an improved and simplified design of said at least one heat dissipating structure for said battery management system (BMS) of said energy storage pack which provides an improved conduction heat transfer between the battery management system (BMS) and said outer casing through said at least one heat dissipating structure, thereby facilitating an effective cooling mechanism for said battery management system (BMS) and hence enhanced performance of said at least one energy storage device.

Advantageously, the present invention provides an improved and simplified design for said at least one heat dissipating structure for said battery management system (BMS) for said at least one energy storage device of the energy storage pack. In one embodiment, said improved said at least one heat dissipating structure includes said at least one airflow guiding portion and said at least one securing portion being extending laterally from said at least a portion of said at least one airflow guiding portion such that said at least a portion of the heat generated by said one or more integrated circuits of said battery management system (BMS) is easily dissipated through conduction heat transfer mechanism to the outer casing and hence to the outside. Furthermore, it is advantageous to provide said securing member of said at least one securing portion of said at least one airflow guiding member which establishes thermal contact of said at least one heat dissipating portion with said outer casing of said at least one energy storage structure to outside and hence facilitates improved dissipation of the heat generated by said one or more integrated circuits of said battery management system (BMS).

Various other features and advantages of the invention are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number. With reference to the accompanying drawings, wherein the same reference numerals will be used to identify the same or similar elements throughout the several views. It should be noted that the drawings should be viewed in the direction of orientation of the reference numerals.

Application of the present invention will be extended to all two-wheeled vehicles, three-wheeled vehicle and four wheeled vehicles.

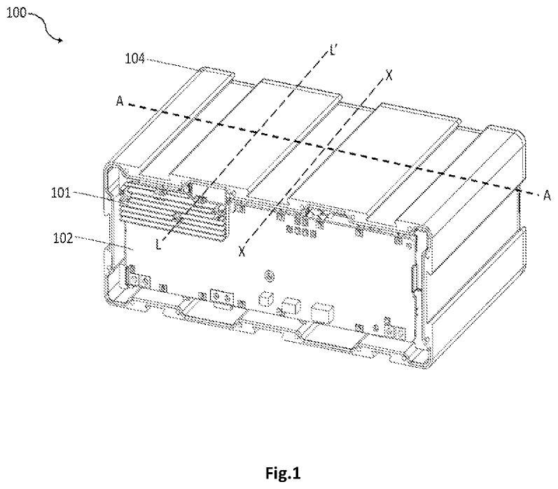

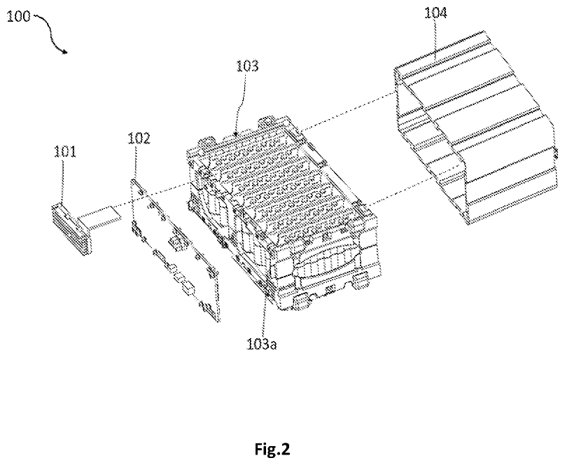

FIG. 1 is a perspective view of the energy storage pack (100), as per one embodiment of the present invention. In one embodiment, said energy storage pack (100) includes said at least one energy storage device (103) (shown in FIG. 2) and the battery management system (BMS) (102) electrically coupled to said at least one side (103a) of said at least one energy storage device (103). As per one embodiment, said at least one heat dissipating structure (101) is slidably positioned to said at least one side (103a) (shown in FIG. 2) of said at least one energy storage device (103) and in alignment thereof.

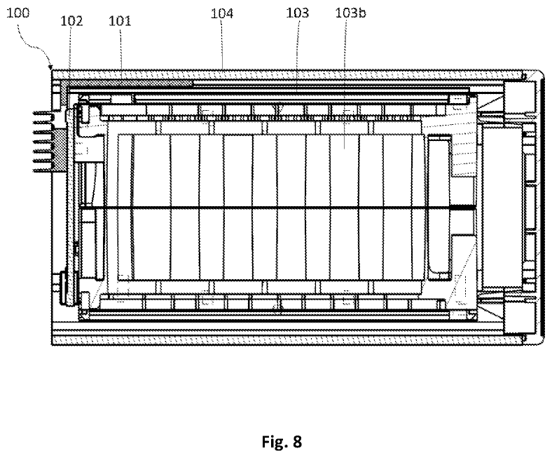

FIG. 2 is an exploded view of the energy storage pack (100) of FIG. 1, as per one embodiment of the present invention. In one embodiment of the present invention, said at least one energy storage device (103) of said at least one energy storage pack (100) comprises of the one or more energy storage cells (103b) (shown in FIG. 8) disposed in one or more series and parallel configuration in at least a portion therein. As per one embodiment, the battery management system (BMS) (102) is electrically coupled to at least one side (103a) of said at least one energy storage device (103). In one embodiment, said at least one heat dissipating structure (101) is configured to be slidably positioned to said at least one side (103a) of said at least one energy storage device (103). Further in FIG. 2, referring to one embodiment, said at least one energy storage pack (100) includes an outer casing (104) configured to accommodate said at least one energy storage device (103) therein.

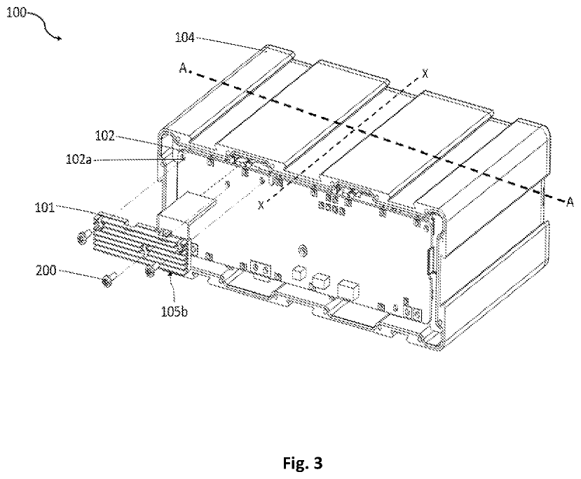

FIG. 3 is an exploded view of the energy storage pack (100) including said at least one heat dissipating structure (101), as per one embodiment of the present invention. In one embodiment, said at least one heat dissipating structure (101) is configured to be slidably positioned to said at least one side (103a) (shown in FIG. 2) of said at least one energy storage device (103). Particularly, in one embodiment, said battery management system (BMS) (102) extends substantially along the length of said at least one energy storage device (103) in a longitudinal axis (AA) thereof. As per one embodiment said battery management system (BMS) (102) includes one or more mounting portions (102a) adapted for detachably securing said at least one heat dissipating structure (101) thereto through the one or more fasteners (200). Further, as per one embodiment, at least a portion of said at least one heat dissipating structure (101) is provided with the plularity of fins (105b) configured to dissipate said at least a portion of the heat generated by said battery management system (BMS) (102) during charging and discharging of said at least one energy storage device (103) to outside. As per one embodiment, said at least one energy storage device (103) (shown in FIG. 2) is accommodated in the outer casing (104) of said energy storage pack (100).

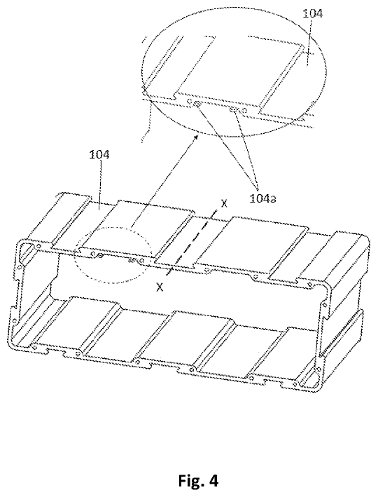

FIG. 4 is a perspective view of the outer casing (104) of the energy storage pack (100) of FIG. 1, as per one embodiment of the present invention. In one embodiment, said outer casing (104) comprises the one or more groove structures (104a) being integrally formed along the transverse direction (XX) with at least a portion of an inner surface thereof.

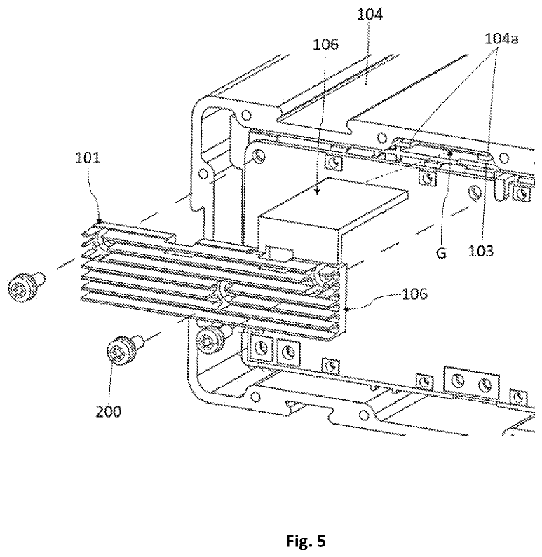

FIG. 5 is an enlarged exploded view of at least a portion of the energy storage pack (100) of FIG. 1 illustrating said at least one heat dissipating structure (101), as per one embodiment of the present invention. In one embodiment, said at least one energy storage device (103) when accommodated in said outer casing (104) forms said at least a gap portion (G) therebetween. Referring to one embodiment, said at least one securing portion (106) is configured for slidably securing said at least one heat dissipating structure (101) to said at least one side of said at least one energy storage device (103) through said at least a gap portion (G) along at least a portion of said one or more groove structures (104a). As per one embodiment, said at least a portion of said at least one heat dissipating structure (101) is detachably secured to said at least a portion of the battery management system (BMS) (102) through said one or more fasteners (200).

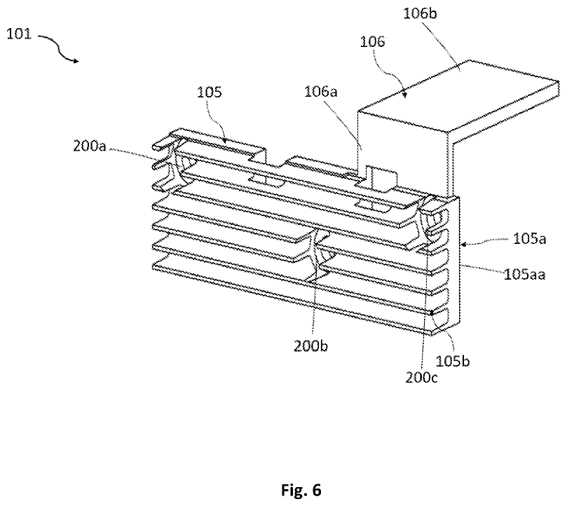

FIG. 6 is perspective view of said at least one heat dissipating structure (101) of said battery management system (BMS) (102) of the energy storage pack (100), as per one embodiment of the present invention. As per one embodiment, said at least one heat dissipating structure (101) includes said at least one airflow guiding portion (105) and said at least one securing portion (106) integrally formed with said at least one airflow guiding portion (105) and extending laterally outward from said at least a portion thereof. In one embodiment, said at least one airflow guiding portion (105) includes the back wall (105a) having said flat surface (105aa) and the plurality of fins (105b) projecting from the opposing side of said flat surface (105aa) of said back wall (105a). As per one embodiment, at least a portion of said at least one airflow guiding portion (105) of said at least one heat dissipating structure (101) includes the one or more fastener receiving portions (200a), (200b), (200c) configured to receive the one or more fasteners (200) (shown in FIG. 5) for detachably attaching said at least one heat dissipating structure (101) to said battery management system (BMS) (102) in said at least one side (103a) of said at least one energy storage device (103) in a sandwich manner. In one embodiment, said at least one securing portion (106) includes an extending member (106a) extending laterally from at least a portion of said back wall (105a) of said at least one airflow guiding portion (105) and the securing member (106b) integrally formed with said extending member (106a) in a substantially perpendicular orientation. As per one embodiment, said at least one airflow guiding portion (105) is positionable in parallel with said at least one energy storage device (103) when said at least one dissipating structure (101) is securely positioned to said at least one side (103a) (shown in FIG. 2) at least one energy storage device (103) (shown in FIG. 1).

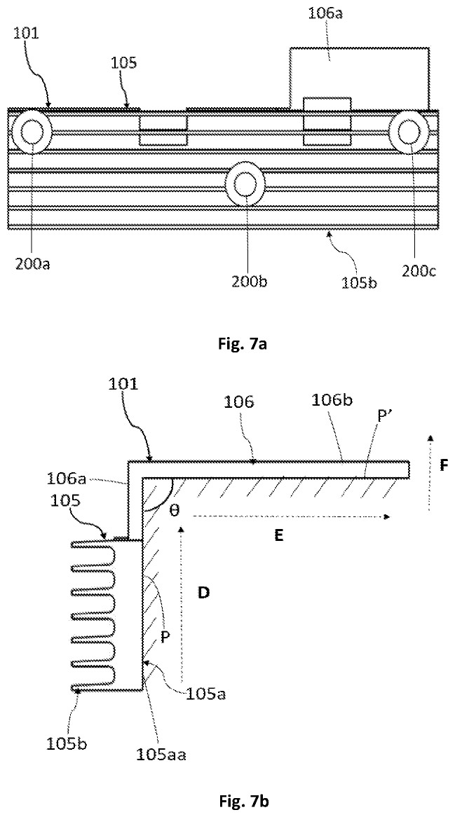

FIG. 7a is a front view of said at least one heat dissipating structure (101) of FIG. 6, as per one embodiment of the present invention. In one embodiment, said at least one airflow guiding portion (105) of said at least one heat dissipating structure (101) includes the one or more fastener receiving portions (200a), (200b), (200c) configured to receive the one or more fasteners (200) (shown in FIG. 5) for detachably attaching said at least one heat dissipating structure (101) to said battery management system (BMS) (102) in said at least one side (103a) of said at least one energy storage device (103) in a substantially orthogonal direction. In one embodiment, said securing member (106a) of said at least one securing portion (106) (shown in FIG. 6) is extending laterally from at least a portion of said at least one airflow guiding portion (105). In one embodiment, said airflow guiding portion (105) includes the plularity of fins (105b) integrally formed with at least a portion thereof.

FIG. 7b is a side view of said at least one heat dissipating structure (101) of FIG. 6, as per one embodiment of the present invention. In one embodiment, said at least one airflow guiding portion (105) includes the plularity of fins (105b) adapted to guide at least a portion of the heat generated by said one or more integrated circuits (not shown) of the battery management system (BMS) (102) to outside. In one embodiment, said at least one securing portion (106) includes an extending member (106a) extending laterally from at least a portion of said back wall (105a) of said at least one airflow guiding portion (105) and the securing member (106b) is integrally formed with said extending member (106a) in a substantially perpendicular orientation. As per one embodiment, the extending member (106a) extends in the common plane (P) with said flat surface (105aa) of said back wall (105a) at the predetermined angle (θ) to the plane (P′) of said securing member (106b) of said at least one securing portion (106). In one embodiment, said extending member (106a) is oriented at said predetermined angle (θ) in the range of 85° to 95° with said securing member (106b) of said at least one securing portion (106). As per one embodiment, said at least one heat dissipating structure (101) is adapted to direct dissipation of said at least some amount of heat generated by at least one circuitry of said battery management system (BMS) (102) through said back wall (105a) and said extending member (106a) along said common plane (P) in the first predetermined direction (D) and through said securing member (106b) along said plane (P′) in the second predetermined direction (E). Further, in one embodiment, the securing member (106b) thermally coupled with the outer casing (104) (shown in FIG. 8) of said at least one energy storage device (103) is configured to guide dissipation of said at least some amount of heat in the third predetermined direction (F) through said outer casing (104). As per another embodiment of the present invention, the airflow guiding portion (105) and the securing portion (106) is separately formed and connected to each other through suitable thermally conductive attaching means.

FIG. 8 is a cross-sectional view of the energy storage pack (100) taken along line LL′ in FIG. 1 along the transverse direction (XX) thereof, as per one embodiment of the present invention. In one embodiment, the energy storage pack (100) comprises said at least one energy storage device (103) including said one or more energy storage cells (103b) disposed in the one or more configuration including series and parallel arrays in at least a portion of said at least one energy storage device (103). In one embodiment, said at least one energy storage device (103) is accommodated in the outer casing (104) of said energy pack (100). In one embodiment, the improved design of said at least one heat dissipating structure (101) is in a contact with said at least a portion of said outer casing (104) of said energy storage pack (100) and facilitates in the dissipation of said at least some portion of said heat generated by said battery management system (BMS) (102) to said at least a portion of said outer casing (104) and hence outside through the conduction heat transfer mechanism and provides an improved cooling mechanism for the battery management system (BMS) (102) of the energy storage pack (100).

Improvements and modifications may be incorporated herein without deviating from the scope of the invention.

We claim:

1. An energy storage pack (100), said energy storage pack (100) comprising:
at least one energy storage device (103);
a battery management system (BMS) (102) electrically coupled to at least one side (103a) of said at least one energy storage device (103); and
at least one heat dissipating structure (101) slidably positioned to said at least one side (103a) of said at least one energy storage device (103) and in alignment thereof, said at least one heat dissipating structure (101) includes at least one airflow guiding portion (105) and at least one securing portion (106) integrally formed with said at least one airflow guiding portion (105) and extending laterally outward from at least a portion thereof.

2. The energy storage pack (100) as claimed in claim 1, wherein said at least one airflow guiding portion (105) includes a back wall (105a) having a flat surface (105aa) and a plurality of fins (105b) projecting from an opposing side of said flat surface (105aa) of said back wall (105a).

3. The energy storage pack (100) as claimed in claim 1, wherein said at least one airflow guiding portion (105) is positionable in parallel with said at least one side (103a) of said at least one energy storage device (103).

4. The energy storage pack (100) as claimed in claim 1, wherein said at least one securing portion (106) includes an extending member (106a) extending laterally from at least a portion of said back wall (105a) of said at least one airflow guiding portion (105) and a securing member (106b) integrally formed with said extending member (106a) in a substantially orthogonal direction.

5. The energy storage pack (100) as claimed in claim 4, wherein said extending member (106a) extends in a common plane (P) with said flat surface (105aa) of said back wall (105a) at a predetermined angle (θ) to a plane (P′) of said securing member (106b) of said at least one securing portion (106).

6. The energy storage pack (100) as claimed in claim 5, wherein said extending member (106a) is oriented at said predetermined angle (θ) in the range of 85° to 95° with said securing member (106b) of said at least one securing portion (106).

7. The energy storage pack (100) as claimed in claim 1, wherein said at least one heat dissipating structure (101) is adapted to direct dissipation of at least some amount of heat generated by at least one circuitry of said battery management system (BMS) (102) through said back wall (105a) and said extending member (106a) along said common plane (P) in a first predetermined direction (D) and through said securing member (106b) along said plane (P′) in a second predetermined direction (E).

8. The energy storage pack (100) as claimed in claim 7, wherein said securing member (106b) thermally coupled with an outer casing (104) of said at least one energy storage device (103) is configured to guide dissipation of said at least some amount of heat in a third predetermined direction (F) through said outer casing (104) to outside.

9. The energy storage pack (100) as claimed in claim 1, wherein said outer casing (104) comprises one or more groove structures (104a) being integrally formed along a transverse direction (XX) with at least a portion of an inner surface thereof.

10. The energy storage pack (100), as claimed in claim 1, wherein said at least one energy storage device (103) when accommodated in said outer casing (104) forms at least a gap portion (G) therebetween.

11. The energy storage pack (100) as claimed in claim 1, wherein said at least one securing portion (106) is configured for slidably securing said at least one heat dissipating structure (101) to said at least one side (103a) of said at least one energy storage device (103) through said at least a gap portion (G) along at least a portion of said one or more groove structures (104a).
